(19) United States
(12) Patent Application Publication
(10) Pub. No.: US 2023/0100623 A1
(43) Pub. Date: Mar. 30, 2023

(54) Safe Delivery Tower

(71) Applicant: Verofax Limited, Abu Dhabi (AE)

(72) Inventor: Wassim MERHEBY, Abu Dhabi (AE)

(21) Appl. No.: 17/952,251

(22) Filed: Sep. 24, 2022

Related U.S. Application Data
(60) Provisional application No. 63/250,465, filed on Sep. 30, 2021.

(51) Int. Cl. G06Q 10/08; G07C 9/00; G07C 9/21; G07C 9/25; G06Q 20/38; G06Q 20/02

(52) U.S. Cl. CPC G06Q 10/0836; G07C 9/00309; G07C 9/00563; G07C 9/00912; G07C 9/21; G07C 9/257; G06Q 20/389; G06Q 20/027

(57) ABSTRACT

A safe delivery container, system and method which permits tracking of the state of the container and controlled release of its contents. Determination of the state of the container is preferably provided according to a plurality of sensors, including without limitation a temperature sensor, GPS tracking device, accelerometer, gyroscope, and an IMU. Tracking of the state of the container is preferably supported through a communication module which may for example comprise a SIM card. Such a communication module preferably enables the sensor signals to be transmitted to a remote location. Alternatively and/or additionally, communication of such sensor signals may occur when the container is brought into communication contact with each of a plurality of local communication devices. Upon receipt of such state information for the container, optionally and preferably the state information is written to a distributed ledger technology (DLT) such as for example the blockchain.

### FIELD OF THE INVENTION

The present invention is of a safe delivery tower, and in particular, to such a safe delivery tower which permits control over and tracking of the state of the safe delivery tower, and controlled release of its contents.

### BACKGROUND OF THE INVENTION

Global manufacturing and transport have enabled a wide variety of goods to be available internationally. With the current COVID-19 situation, many consumers are purchasing goods through online retailers and are having such goods delivered to their homes or offices. Brick and mortar (physical) retailers, manufacturers and others have continued to receive delivery of goods, which has been rendered more difficult due to physical distancing requirements and other restrictions to ensure employee safety. Indeed, the sheer volume of delivered goods and the need to ensure safe receipt thereof has itself posed a significant challenge.

### BRIEF SUMMARY OF THE INVENTION

The present invention, in at least some embodiments, is of a safe delivery tower which permits control over and tracking of the state thereof, and controlled release of its contents. Determination of the state of the tower is preferably provided according to a plurality of sensors, including without limitation a temperature sensor, motion sensor and a camera. Tracking of the state of the tower is preferably supported through a communication module which may for example comprise a SIM card. Such a communication module preferably enables the sensor signals to be transmitted to a remote location. Alternatively and/or additionally, communication of such sensor signals may occur when the container is brought into communication contact with each of a plurality of local communication devices, such as for example and without limitation a mobile communication device and/or a near field communication (NFC) device.

Upon receipt of such state information for the tower, optionally and preferably the state information is written to a distributed ledger technology (DLT) such as for example the blockchain.

Controlled release of the contents is preferably provided through an electronic smart lock. The electronic smart lock preferably only opens upon receipt of a signal indicating that an authorized recipient wishes to access the contents. Such a signal may be provided for example through one or more of an NFC ID card reader, biometric sensor, communication with a smart device, entry of a code and/or remote transmission of an unlocking signal.

The biometric sensor may comprise for example one or more of fingerprint, palmprint, voice analysis, retinal scan, iris scan and/or facial identification. Optionally each container has a unique serialized QR code. The secure tower preferably supports contactless delivery. This is accomplished through validation, for example by scanning the QR code on the tower or a specific part of the tower, through an NFC card reader signal, biometric sensor signal, communication with a smart device, entry of a code and/or remote transmission of an unlocking signal. Some combination of these methods may also be used.

The specific part of the tower may for example be a drawer, separated fixed section with a separate door and the like. The tower may also comprise a single interior space, accessed through one or more doors or other coverings.

Various methods may be used to operate the tower for providing secure delivery of products. For example, preferably the delivery agent is able to receive contactless access in a secure manner, for example through a mobile device camera to scan a QR code on a door and/or drawer of the tower. The mobile device also preferably features software and/or is able to access software operated through a cloud service, such that scanning the QR code confirms authorization to access the tower or a part thereof. Upon confirmed authorization, the door and/or door opens, thereby providing access to the tower or the part thereof for the delivery agent, who is then able to place the product and/or container containing same into the tower or part thereof.

The delivered product is then locked in the safe delivery tower which is preferably only able to be opened by an authorized recipient, for example through the above mechanism of scanning a QR code with a mobile device camera and then operating software to enable the tower or part thereof to be accessed, for example by opening a door and/or drawer.

Preferably, tracking of the state of the tower, including with regard to the contents stored therein, is then recorded through digital certification for the tower, which is saved on a distributed ledger such as the blockchain. Such tamperproof storage ensures verified tracing of the product at the “last mile” or delivery of the product.

Non-limiting examples of products for which such a secure tower may be used include pharmaceuticals, medical devices and other medical products; non-medical chemicals; food and beverages; cosmetics; jewelry, precious metals and gemstones; fashion, including without limitation clothing, shoes, handbags and other accessories; art, including without limitation paintings and sculpture; electronic products and parts; and spare machine parts, including without limitation automobile parts.

Without wishing to be limited by a closed list, among the advantages of the tower is that whenever an unauthorized user tries to open the tower or tamper with the tower, an alert may be sent to the responsible party. Thus privacy of the products inside the tower is maintained, such that only an authorized party may open the tower, and view or otherwise remove or access the products inside the tower.

Among other non-limiting advantages of the secure tower include provision of contactless delivery, optionally sanitizing the product before the receiver collects it, temperature control when required, asynchronous delivery and collection such that the receiver need not be present in person to collect the product, and storage of records on a blockchain.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows a first view of a non-limiting exemplary tower with a plurality of separated sections that may be opened individually;

FIG. 2 shows a second view of a non-limiting exemplary tower with a plurality of separated sections that may be opened individually;

FIG. 3 shows a third view of a non-limiting exemplary tower with a plurality of separated sections that may be opened individually;

FIG. 4 shows a fourth view of a non-limiting exemplary tower with a plurality of separated sections that may be opened individually;

FIG. 4B shows a side view of an open drawer;

FIGS. 5 and 6 show frontal cut-away views of the interior of the tower in a non-limiting, exemplary embodiment;

FIGS. 7A-7C show exemplary methods for operating the tower; and

FIG. 8 shows a schematic block diagram of an exemplary control system for the tower.

### DESCRIPTION OF AT LEAST SOME EMBODIMENTS

Any suitable blockchain which involves a distributed ledger, which preferably requires some type of cryptography, more preferably a public/private key encryption system, or hash or digital signatures, may optionally be used. Once a change — such as for example tracking the state of the container and determining an updated state — is made and is written to the distributed ledger, this change is automatically securely, and in a non-falsifiable manner, that is completely accurately replicated to all network participants.

The nature of the distributed ledger is such that all parties to a transaction can see the details of the transaction and optionally further requirements for the transaction to be complete.

Such a distributed ledger would also have the advantage of fraud prevention with immutable, append-only Distributed Ledger Technology. For example, users attempting to fraudulently trade cryptocurrency units that they do not possess would be blocked.

A blockchain or blockchain is a distributed database that maintains a list of data records, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. One well-known application of a blockchain is the public ledger of transactions for cryptocurrencies such as used in bitcoin. The data records recorded in the blockchain are enforced cryptographically and stored on the nodes of the blockchain.

A blockchain provides numerous advantages over traditional databases. A large number of nodes of a blockchain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the blockchain that creates a transaction can determine within a level of certainty whether the transaction can take place and become final by confirming that no conflicting transactions (i.e., the same currency unit has not already been spent) confirmed by the blockchain elsewhere.

The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain. For example, in the case of cryptocurrencies, a valid transaction is one that is digitally signed, spent from a valid digital wallet and, in some cases, which meets other criteria. In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

Preferably the blockchain(s) that is/are implemented are capable of running code, to facilitate the use of smart contracts. Smart contracts are computer processes that facilitate, verify and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, which may be restricted at varying levels for different people, to the terms and logic of the contract. Smart contracts typically include logic that emulates contractual clauses that are partially or fully self-executing and/or self-enforcing. Examples of smart contracts are digital rights management (DRM) used for protecting copyrighted works, buying or selling goods, whether or virtual or physical, executing transfers of goods or of rights associated with such goods, and the like.

Smart contracts may also be described as pre-written logic (computer code), stored and replicated on a distributed storage platform (e.g. a blockchain), executed/run by a network of computers (which may be the same ones running the blockchain), which can result in ledger updates (transfer of digital rights, etc.).

Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

Not all blockchains can execute all types of smart contracts. For example, Bitcoin cannot currently execute smart contracts. Sidechains, i.e. blockchains connected to Bitcoin's main blockchain could enable smart contract functionality: by having different blockchains running in parallel to Bitcoin, with an ability to jump value between Bitcoin's main chain and the side chains, side chains could be used to execute logic. Smart contracts that are supported by sidechains are contemplated as being included within the blockchain enabled smart contracts that are described below.

For all of these examples, security for the blockchain may optionally and preferably be provided through cryptography, such as public/private key, hash function or digital signature, as is known in the art.

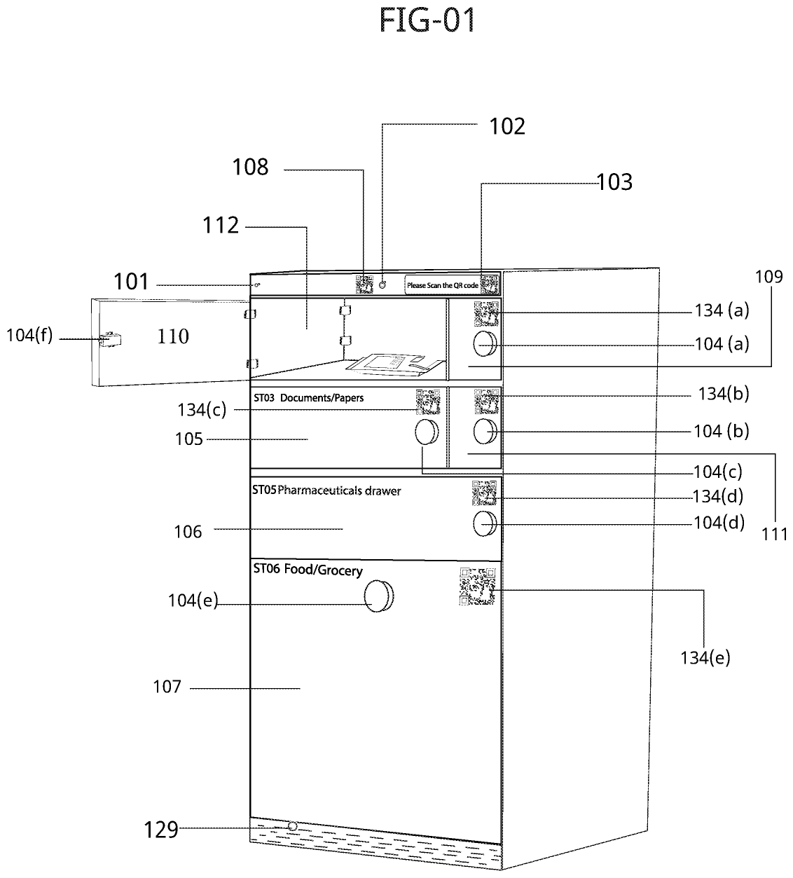

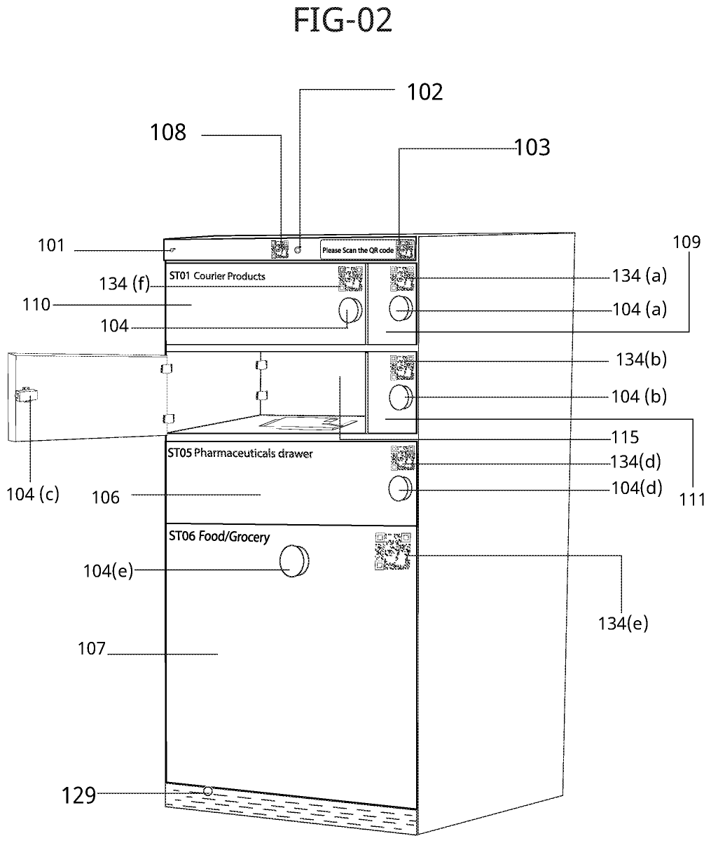

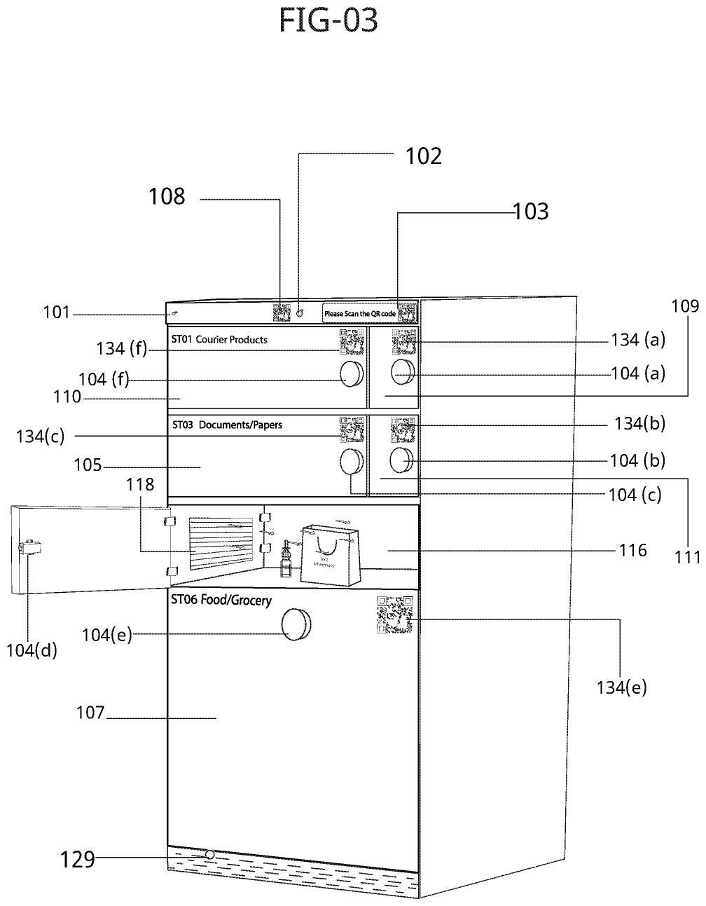

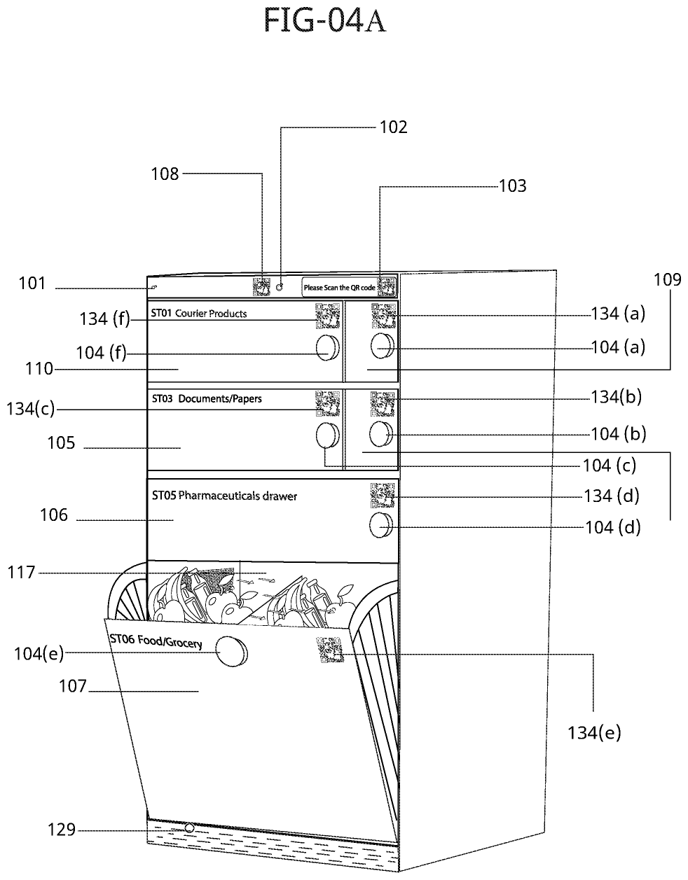

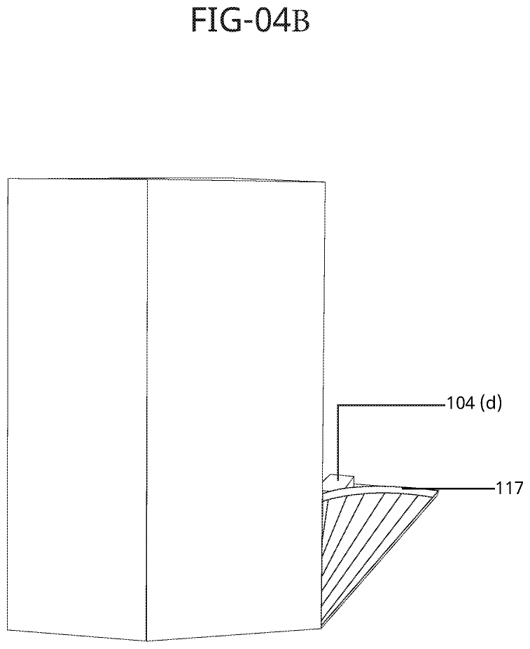

FIGS. 1-4B show a non-limiting exemplary tower with a plurality of separated sections that may be opened individually. Each of FIGS. 1-4A shows a different exemplary open section, while FIG. 4B shows a side view of an open drawer. FIG. 1 shows drawer 1: courier drawer; FIG. 2 shows drawer 2: files and documents drawer; FIG. 3 shows drawer 3: pharmaceutical drawer; and FIG. 4A shows drawer 4: food and groceries. Of course, different products and different arrangements of drawers are possible and are contemplated within the present invention.

As shown in FIG. 1, a tower 100 features a plurality of drawers, which are numbered separately, and which are described below. Optionally, at least one drawer may feature temperature control as described below, for temperature sensitive goods such as perishable foodstuffs for example. Tower 100 also features a motion sensor 101 and/or a video camera 102. Motion sensor 101 and video camera 102 both provide additional security for tower 100. Although the drawers are preferably provided with smart electronic locks as described below, articles placed in the drawers may be valuable and so further security measures are desirable.

Tower 100 may also feature an information panel 103, such as an instructional QR code or other means for providing instructions in regard to operation of the drawers. A QR code 108 or other smart label may be used to identify the specific tower unit.

Tower 100 preferably features a cooling unit 129 to maintain temperature control, as described in greater detail below.

Starting from the top, tower 100 features a courier drawer 112, which in this non-limiting example is intended to provide access for items for pick up by a courier, which is shown as open. Courier drawer 112 is open and accessible to placing products within, or retrieving products therefrom. To open courier drawer 112, an electronic lock 104f is placed in the unlocked position and then a door 110 may be opened. Electronic lock 104f is preferably a smart electronic lock. The accessible portion of electronic lock 104f that enables it to be open is not shown in this view.

Electronic lock 104f preferably only opens upon receipt of a signal indicating that an authorized recipient wishes to access the contents. Such a signal may be provided for example through one or more of an NFC ID card reader, biometric sensor, communication with a smart device, entry of a code and/or remote transmission of an unlocking signal. In this non-limiting example, each drawer preferably features a QR code, shown as QR code 134c for a documents drawer 105; QR code 134d for a pharmaceuticals drawer 106; QR code 134e for a food or groceries drawer 107; and (shown in FIGS. 2-4) QR code 134f for courier drawer 112. To gain access to each drawer, optionally an authorized user scans the corresponding QR code with a QR code reader, which may for example comprise a smart phone or other mobile device with a camera (not shown). Upon scanning the QR code, a signal

The biometric sensor may comprise for example one or more of fingerprint, palmprint, voice analysis, retinal scan, iris scan and/or facial identification. Optionally each container has a unique serialized QR code. The secure container preferably supports contactless delivery. This is accomplished through validation, for example by scanning the QR code on the box, through an NFC card reader signal, biometric sensor signal, communication with a smart device, entry of a code and/or remote transmission of an unlocking signal. Some combination of these methods may also be used.

Tower 100 may also feature two separate payment drawers, shown as drawers 109 and 111. Drawer 109 may be used for example to place payment for the courier so that when items are retrieved from courier drawer 112, the courier is also able to retrieve payment from drawer 109. Similarly, payment for items delivered to any of the other drawers may be made through drawer 111.

Drawer 109 features an electronic lock 104a, which is also preferably a smart electronic lock as described above. Drawer 109 features some type of identifier, such as for example a QR code 134a, which may be used as described above. Drawer 111 features an electronic lock 134b and a QR code 134b, which may be used as described above.

Turning now to FIG. 2, tower 100 is shown as described above, but now with a view in which courier drawer 112 is closed and documents drawer 105 is open. FIG. 3 shows a view with all drawers closed except for pharmaceutical drawer 106, which is open. Pharmaceutical drawer 106 is designed to receive medicines which are often sensitive to temperature, such that preferably a vent 118 is present to permit cooling air from cooling unit 129 to be blown in. Preferably a temperature controller within pharmaceutical drawer 106 determines the amount of cool air which is to be blown in. A number of packages of medicines 116 may be placed within pharmaceutical drawer 106.

FIG. 4A shows food or groceries drawer 107 as open. Items to be stored in food or groceries drawer 107 may be perishable, such that cooling unit 129 provides cooling air to control the temperature. Food or groceries drawer 107 may feature two compartments, including a frozen goods compartment 116, which preferably receives more cold air to maintain these goods in a frozen statement. One or more other compartments may be provided for non-frozen goods, with a higher temperature maintained.

FIG. 4B shows a side view of food or groceries drawer 107 in an open position.

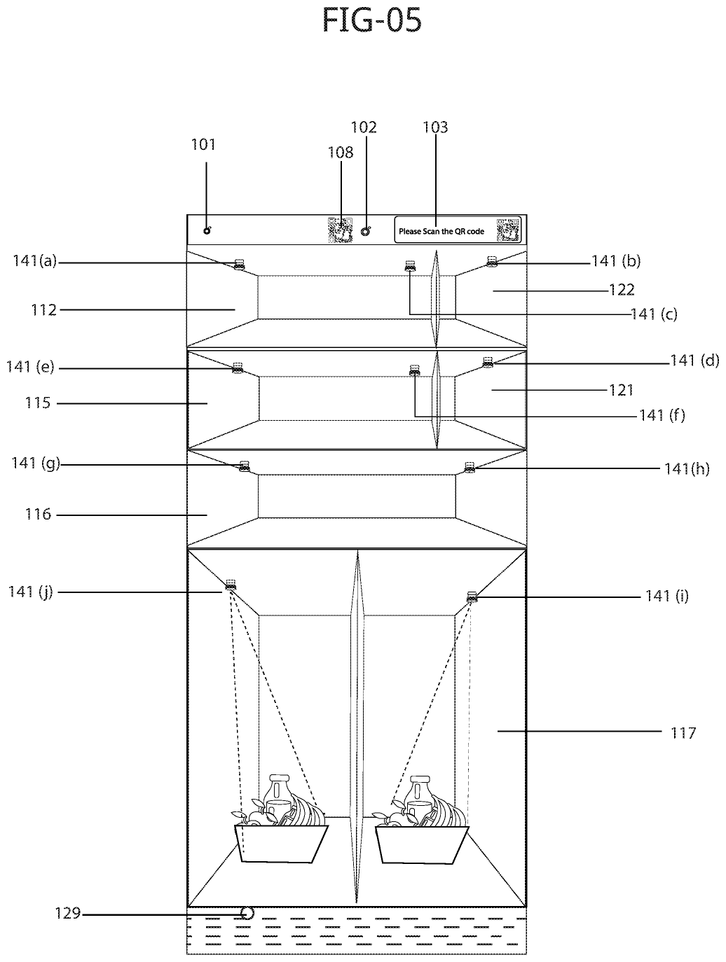

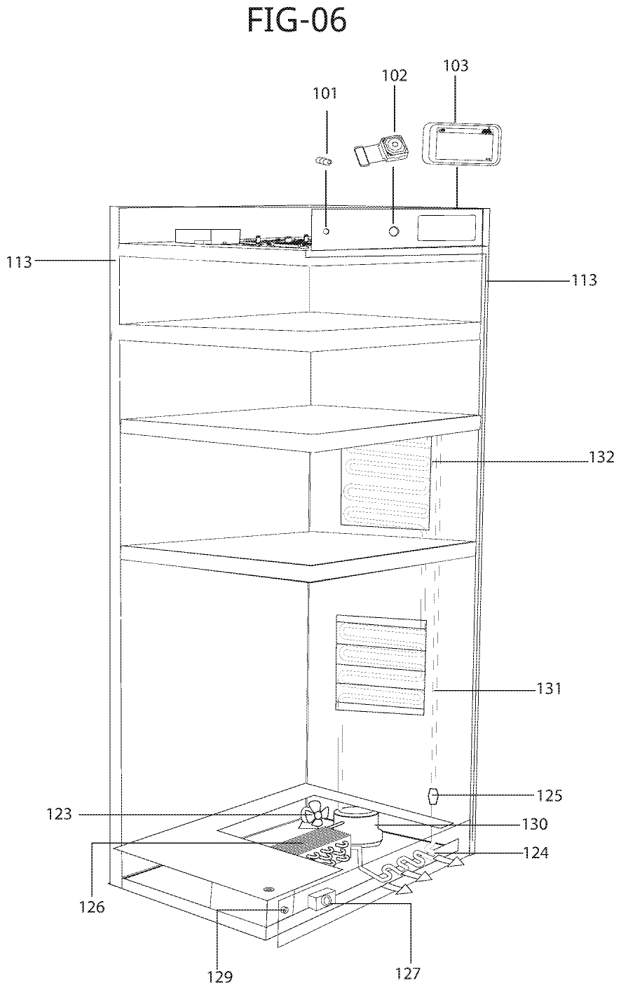

FIGS. 5 and 6 show cut-away views of the interior of the tower in a non-limiting, exemplary embodiment. FIG. 5 shows a frontal cut-away view of the tower, while FIG. 6 shows a cut-away view with the electronics and other control components exposed.

Turning now to FIG. 5, tower 100 features a plurality of temperature and/or security control components. Items with the same numbers as FIGS. 1-4A have the same or similar function.

For example, control components 141a-141i may comprise video cameras, temperature sensors, UV/disinfectant lights or a combination thereof. Preferably at least disinfectant lights are present in each drawer. Preferably, for each of the drawers intended for receiving physical goods, specifically documents drawer 105; pharmaceuticals drawer 106; food or groceries drawer 107; and courier drawer 112; one control component 141 comprises a video camera while a second control component 141 comprises a temperature sensor, optionally also combining a UV/disinfectant light. For payment drawers 109 and 111, optionally only a temperature sensor is present for a single control component 141. The temperature sensors may be used to determine overall cooling of tower 100 by cooling unit 129. Video cameras may record opening of each drawer and placing items within, or retrieving items from, that drawer. Such information may be transmitted to a remote location for example, to provide a record of interactions with tower 100.

FIG. 6 shows a cut-away view of tower 100 with the electronics and other control components exposed. Items with the same reference numbers as in FIGS. 1-4A have the same or at least similar function. Motion sensor 101 and video camera 102 are shown as illustrative components. A wireless communication module is not shown but is present, which enables communication to and from tower 100. As described previously, such communication may enable permission to open a drawer to be granted, for example after scanning a QR code and entering identity information. Such communication may also enable security video footage, temperature status and more to be communicated from tower 100 to a remote monitoring location.

Walls 113 of tower 100 are preferably insulated, to provide temperature control. In addition, walls 113 preferably comprise a material which also preserve the security of the contents of the drawers.

Walls 113 may have vents which enable cold air to be provided to the drawers, for temperature stability and control, as shown with regard to vents 131 and 132. A valve 125 is able to draw off excess water if present, for example due to condensation, thereby preventing an overflow into the cooling system. Cooling coils 126 cool the air through a compressor 130, which is then blown through vents 131 and 132 by a fan 123. The front of cooling unit 129 features a vent 124 for the hot air from the action of compressor 130 to exit.

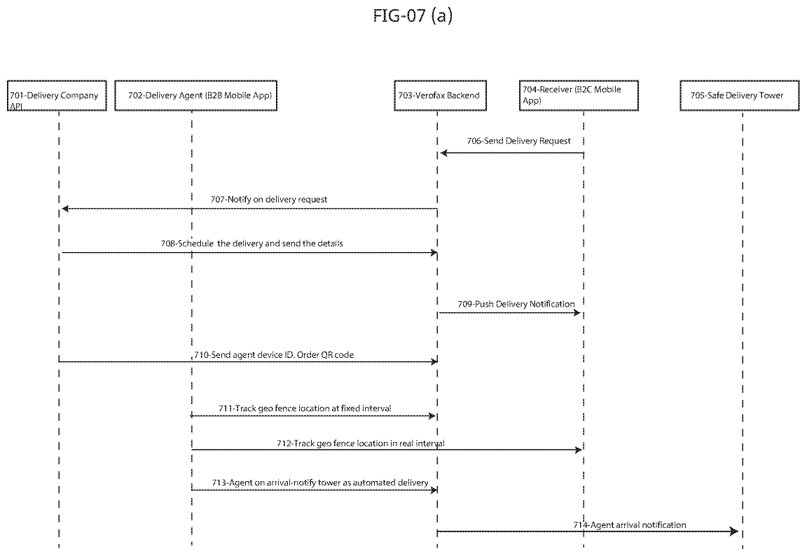

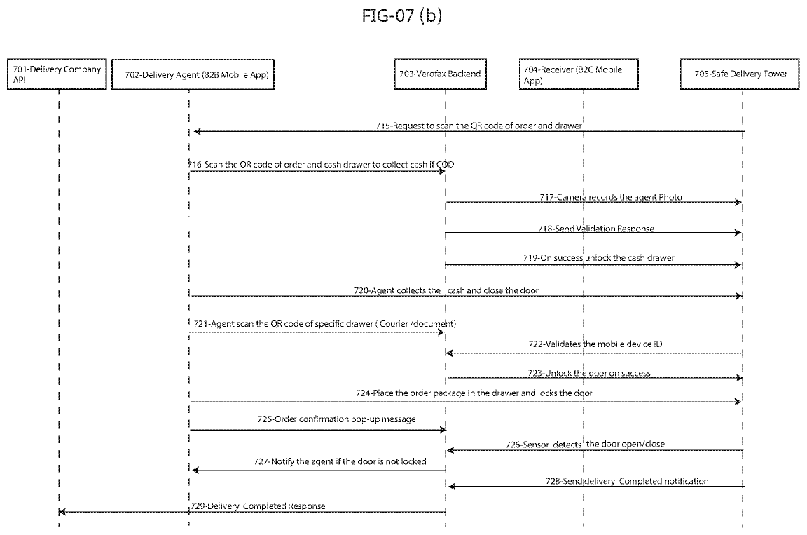

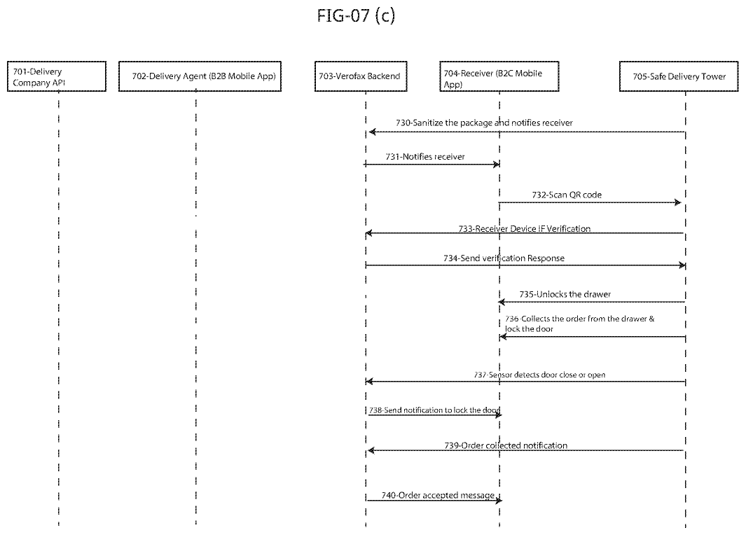

FIGS. 7A-7C show exemplary methods for operating the tower. Turning now to FIG. 7A, a flow is shown between a delivery company API 701, which is able to receive requests for delivery and/or pick up of physical goods, and is able to direct a driver to fulfill such requests through a delivery agent app 702. A backend 703 receives requests from a receiver app 704 and is able to direct these requests to delivery company API 701. Physical goods are delivered to, and are picked up from, a delivery tower 705, for example as described in FIGS. 1-6.

The flow begins when a customer, which may be a consumer or a business, places an order for a delivery at 706 through receiver app 704. Next, backend 703 notifies delivery company API 701 at 707. Delivery company API 701 then verifies details and the schedule for delivery with backend 703 at 708. Backend 703 then notifies receiver app 704 at 709. At 710, delivery company API 701 sends the agent identification information and also generates the QR code, which is sent to backend 703. Delivery agent 702 reports the location of the delivery itself periodically to backend 703 through geofencing at 711. Receiver app 704 is also able to track the location of the delivery in real time through having this information relayed at 712.

At 713, on arrival to the tower location of delivery tower 705, delivery agent 702 sends a request to backend 703, to notify delivery tower 705. Backend 703 then notifies delivery tower 705 of the identity of the delivery person and of their arrival.

In FIG. 7B, delivery tower 705 sends a request to delivery agent 702 at 715, to scan the QR code specific to the order and to the drawer. At 716, delivery agent 702 at least scans the QR code of the drawer for the delivery, and optionally also for the cash drawer if the order is for retrieval of goods and/or is COD (cash on delivery). At 717, delivery tower 705 records the photo of the delivery person and sends it to backend 703. At 718, backend 703 sends a verification response if the photo shows that the delivery person is permitted to deliver the goods. If in fact verification has occurred, then at 719 backend 703 directs delivery tower 705 to unlock the necessary drawer(s). If payment is required, then the first drawer to be unlocked is the cash drawer.

Next, at 720 the delivery person opens the cash drawer and retrieves the cash. At 721, delivery agent 702 scans the QR code for the drawer into which the delivery is to be placed or goods are to be retrieved. At 722, safe delivery tower 705 validates the mobile device identifier for delivery agent 702 and/or validates the order or other information. Validation may occur at safe delivery tower 705 or through communication with backend 703. If the latter, then at 723, backend 703 confirms that the door with the scanned QR code can be unlocked and directs delivery tower 705 to unlock it.

At 724, the delivery person places the physical goods in the drawer and/or retrieves physical goods from the drawer, and locks the drawer. At 725, delivery agent 702 receives a pop-up message confirming delivery with backend 703. At 726, delivery tower 705 confirms each time that the door is opened or closed to backend 703, through operation of a sensor. At 727, if the door has not been properly locked, delivery tower 705 sends a notification to backend 703 which then notifies delivery agent 702. Once the door is properly locked and delivery is complete, delivery tower 705 sends a notification to backend 703 at 728. At 729, backend 703 confirms completion of delivery to delivery company API 701.

Turning now to FIG. 7C, delivery tower 705 sanitizes the package and notifies backend 703 at 730. At 731, backend 703 notifies receiver app 704. When the recipient wants to retrieve the goods, they bring receiver app 704 to delivery tower 705 and scan the QR code at 732. Delivery tower 705 confirms the identity of the recipient through receiver app 704 with backend 703, at 733. If verified, backend 703 sends a verification response at 734 to delivery tower 705. At 735, delivery tower 705 unlocks the drawer. The recipient retrieves the goods and relocks the drawer at 736.

At 737, the sensor at delivery tower 705 detects that a drawer is locked or unlocked, and notifies backend 703. If the drawer is unlocked, then backend 703 notifies delivery tower 705 and/or the receiver app 704 at 738. Once the order has been collected, notification of order collection is sent from delivery tower 705 to backend 703 at 739. At 740, backend 703 sends notification of delivery being retrieved to receiver app 704.

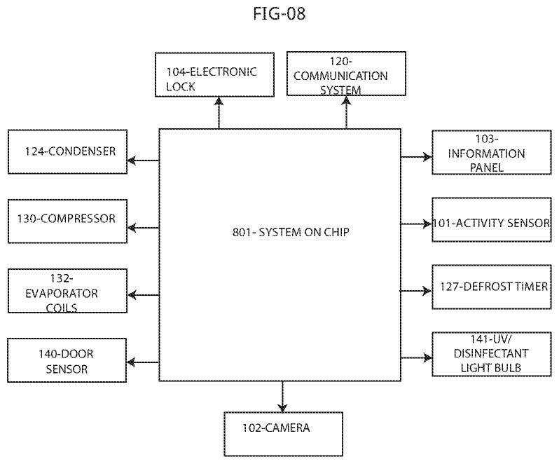

FIG. 8 shows a schematic block diagram of an exemplary control system for the tower. A system on chip 801 features controls for electronic lock 104, communication system 120, information panel 103, activity sensor 101, defrost timer 127, UV/disinfectant light 141, camera 102, door sensor 140, evaporator coils 132, compressor 130 and condenser 124. System on chip 801 comprises a processor and memory, in which the memory stores instructions that are executed by the processor, thereby enabling the functions of the safe delivery tower to be managed.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for providing traceability, comprising a safe delivery container with a traceable state, comprising a space for holding a product; a sensor for providing signals regarding a state of the container; a communication module for communicating said signals; and a security device for securing the container; a distributed ledger technology (DLT) for recording said state of said container; and a server for receiving such signals from said communication module and for determining said state according to said signals, and for recording said state on said DLT, wherein said sensor comprises one or more of a temperature sensor, GPS tracking device, accelerometer, gyroscope, and an IMU; wherein said container comprises a lid, a plurality of walls and a floor, wherein said space is defined by said lid, said plurality of walls and said floor; wherein said security device comprises an electronic smart lock for securing said lid to at least one wall.

2. The system of claim 1, wherein said communication module comprises a cellular communication device and wherein said cellular communication device comprises a SIM card.

3. The system of claim 1, further comprising a local communication device, wherein said container is brought into communication contact with said local communication device, wherein said local communication device comprises one or more of a mobile communication device or a near field communication (NFC) device.

4. The system of claim 3, wherein said electronic smart lock opens upon receipt of a signal indicating that an authorized recipient wishes to access said container.

5. The system of claim 4, wherein said signal comprises an authorization code and said security device comprises a code entry device for receiving said authorization code.

6. The system of claim 5, wherein said authorization code comprises an OTP (one time password).

7. The system of claim 4, wherein said signal comprises a remote authorization signal received through said communication module.

8. The system of claim 4, further comprising a user app and a user computational device for operating said user app, wherein said remote authorization signal is sent through said user app.

9. The system of claim 8, wherein said user computational device communicates with said server for determining authorization of said user app and for sending said remote authorization signal.

10. The system of claim 4, wherein said signal comprises an NFC ID card signal and said security device further comprises an NFC ID card reader for receiving said signal.

11. The system of claim 4, wherein said signal comprises a biometric signal and said security device further comprises a biometric sensor for receiving said signal.

12. The system of claim 11, wherein said biometric sensor comprises one or more of fingerprint, palmprint, voice analysis, retinal scan, iris scan and/or facial identification.

13. The system of claim 4, wherein said container comprises an external visual code and said signal comprises an authenticated scan of said external visual code.

14. The system of claim 13, wherein said visual code comprises a QR code.

15. The system of claim 4, wherein said server sets said signal and authentication.

16. The system of claim 4, wherein said signal and authentication is determined locally at said container, before a product is placed therein.

17. The system of claim 4, wherein said security device comprises an identification device for generating and/or receiving said authentication signal, and said identification device is set into said lid; and wherein said lid further comprises said sensor(s) and said communication module.

18. The system of claim 1, wherein said DLT comprises a blockchain; the system further comprising a blockchain gateway, wherein said blockchain gateway is in communication with said server for reading from and writing to said blockchain; wherein said container is directly in communication with said blockchain gateway; and wherein said blockchain further comprises a smart contract, wherein said smart contract executes if said state of said container exceeds one or more permitted boundaries; or alternatively, wherein said smart contract executes if said state of said container stays within one or more permitted boundaries during a specified period.

19. The system of claim 18, wherein said specified period corresponds to shipment of a product contained within said container.

20. The system of claim 19, wherein said server receives signals from said sensor and determines whether said state of said container exceeds one or more permitted boundaries.
